(19) United States
(12) Patent Application Publication
(10) Pub. No.: US 2017/0301449 A1
(43) Pub. Date: Oct. 19, 2017

(54) ELECTRICAL TRANSFORMER SYSTEMS AND METHODS

(71) Applicant: ABB Schweiz AG, Baden (CH)

(72) Inventors: Adam Michalik, Krakow (PL); Patricia Ricketts, South Boston, VA (US); Massimo Carmignoto, Monselice (IT); Jayram Yadava, Gujarat (IN); Roberto Zannol, Monselice (IT); Milijenko Hrkac, Monselice (IT); Allesandro Maltozzi, Vaesteras (SE); Claire Pitois, Ludvika (SE); Emmanouil Logakis, Baden-Daettwll (SE); Harald Martini, Vasteras (SE); Ilario Scian, Vaasa (SE); Orlando Girlandra, Vaesteras (SE); Rudi Velthuis, Baden-Daettwil (SE); Spiros Tzavalas, Espoo (FI)

(21) Appl. No.: 15/586,201

(22) Filed: May 3, 2017

Related U.S. Application Data
(63) Continuation of application No. PCT/US2015/058993, filed on Nov. 4, 2015.
(60) Provisional application No. 62/075,228, filed on Nov. 4, 2014.

(51) Int. Cl. H01F 27/00; H01F 27/10; H01F 27/23; H01F 27/02; H01F 27/24; H01F 27/28; H02J 3/18

(52) U.S. Cl. CPC H01F 27/006; H01F 27/008; H01F 27/23; H01F 27/10; H01F 27/025; H01F 27/24; H01F 27/28; H01F 2027/406

(57) ABSTRACT

An electrical transformer includes a coil pack including windings, and spacers axially spacing turns of the windings from one another and being formed of a thermoplastic material. Sticks couple and position the spacers. The coil pack has high resistivity to creep and permits temperature rise without degradation of transformer insulation, providing for extended service life and unique methods of transformer system upgrade.

### TECHNICAL FIELD

The present disclosure relates generally to an electrical transformer, and relates more particularly to transformer servicing and coil pack components and related methodology for aging and temperature rise-resistance.

### BACKGROUND

Electrical transformers are widespread and used throughout the world at scales ranging from the miniature, as in home electronics and the like, to vastly larger units employed in connection with power generation and transmission system. The manner in which transformer components are assembled, packaged and designed for extended service life, and the design of components specialized for such ends are areas of interest.

In one aspect a method of servicing a transformer system comprises disassembling a used coil pack from a core of a transformer, where the used coil pack includes a first plurality of winding disks axially spaced apart from one another by a plurality of spacer members comprising a cellulosic material; assembling a substitute coil pack with the core, where the substitute coil pack includes a second plurality of winding disks axially spaced apart from one another by a second plurality of spacer members comprising a non-cellulosic material; and placing the substitute coil pack within the same spatial footprint in the transformer that was occupied by the used coil pack. Certain forms further comprise operating the transformer system with the substitute coil pack at substantially the same power as the transformer system with the used coil pack wherein the substitute coil pack exhibits a lower operating temperature rise than the used coil pack at substantially the same operating power. In certain forms the non-cellulosic material includes a thermoplastic material. Certain forms further comprise operating the transformer system with the substitute coil pack at a higher power than the transformer system with the used coil pack wherein the substitute coil pack exhibits an operating temperature that is the same as or lower than the operating temperature of the used coil pack.

In another aspect, a method of preparing a transformer system for service includes receiving a winding sub-assembly having a coil of winding defining a center axis, spacers positioned between turns of the windings, and axially extending sticks coupling together circumferentially aligned columns of the spacers. The method further includes positioning a first and a second winding table at opposite axial ends of the coil, such that the winding subassembly and winding tables form a coil pack having a starting axial height. The method further includes applying axial compressive force to the winding tables so as to preload the coil pack and shorten the coil pack from the starting axial height to an in-service axial height. The method still further includes installing the coil pack for service in the transformer system at the in-service axial height as determined by the applied axial compressive force.

In still another aspect, an electrical transformer system includes a housing, and liquid cooling system including ports to an interior of the housing. The system further includes a transformer within the interior of the housing and including a core, and coil pack coupled with the core. The coil pack includes disk windings of conductive material forming a coil defining a center axis and having a first axial end and a second axial end, and including a plurality of turns about the center axis between the first axial end and the second axial end. The coil pack further includes a plurality of spacers formed of thermoplastic head resistant material and positioned between adjacent ones of the disk windings. The coil pack further includes a plurality of sticks coupling together circumferentially aligned columns of the plurality of spacers, and a first and a second winding table positioned at the first and second axial ends, respectively. The coil pack further defines a spatially non-uniform heat generation profile with a plurality of hot spots located within a flow path of the coolant fluid through the coil pack. The coil pack further includes nonporous insulators within the hot spots and porous insulators not within the hot spots. The porous insulators are formed of a material having a lower heat transference surface texture, and the nonporous insulators are formed of a material having a higher heat transference surface texture so as to desensitize the transformer to temperature rise.

In still another aspect, a method of field servicing a transformer system includes disassembling a used coil pack from a transformer core within a transformer housing, where the used coil pack includes winding and a plurality of spacers formed of a porous cellulosic insulting material and positioned between adjacent turns of the windings in the used coil pack. The method further includes assembling a substitute coil pack with the transformer core, where the substitute coil pack includes windings defining a center axis and a plurality of spacers formed of a nonporous cellulosic insulating material and positioned between adjacent disk windings in the substitute coil pack. The method still further includes applying a preload to the substitute coil pack so as to reduce an axial height of the coil pack to an in-service axial height, drying the substitute coil pack as assembled with the transformer core and preloaded, and connecting the substitute coil pack with electrical circuitry of the transformer system for service therein.

In still another aspect, a method of preparing a transformer system for service includes receiving a winding subassembly having windings defining a center axis, spacers positioned between disk windings, and axially extending sticks coupling together circumferentially aligned columns of the spacers. The method further includes positioning a first and a second winding table at opposite axial ends of the windings, such that the winding subassembly and winding tables form a coil pack having a starting axial height, and installing the coil pack within a housing of the transformer system and assembling the coil pack with a transformer core. The method still further includes applying axial compressive force to the winding stables to so as to preload the coil pack and shorten the coil pack from the starting axial height to an in-service axial height while installed within the transformer housing and assembled with the transformer core, and connecting the coil pack with electrical circuitry of the transformer system for service therein.

In still another aspect, an electrical transformer system includes a housing, and a fluid cooling system having ports to an interior of the housing. The system further includes a transformer within the interior of the housing and including a core, and coil pack coupled with the core. The coil pack includes windings defining a center axis and having a first axial end and a second axial end, and a plurality of turns about the center axis between the first axial end and the second axial end. The coil pack further defines a spatially non-uniform heat generation profile with a plurality of hot spots located within a flow path of the fluid through the coil, and including nonporous insulators within the hot spots and porous insulators not within the hot spots. The porous insulators are formed of a material having a lower heat transference surface texture, and nonporous insulators are formed of a material having a higher heat transference surface texture.

### BRIEF DESCRIPTION OF THE DRAWINGS

FIG. 1 is a front view of a coil pack for an electrical transformer, according to one embodiment;

FIG. 2 is a diagrammatic view of a coil pack at one stage of a process, according to one embodiment;

FIG. 3 is a diagrammatic view of the coil pack of FIG. 2 at another stage of the process;

FIG. 4 is a sectioned view, in perspective, of a portion of coil pack positioned about a transformer core, according to one embodiment;

FIG. 5 is a top view of a spacer for use in a coil pack for an electrical transformer, according to one embodiment;

FIG. 6 is a perspective view of the spacer of FIG. 5;

FIG. 7 is a diagrammatic view of the coil pack of FIG. 2 at another stage of the process;

FIG. 8 is a diagrammatic view of the coil pack of FIG. 2 at another stage of the process;

FIG. 9 is a partially sectioned side diagrammatic of a coil pack at one stage of another process, according to one embodiment; and

FIG. 10 is a partially open side diagrammatic view of a transformer system, according to one embodiment.

### DETAILED DESCRIPTION OF ILLUSTRATIVE EMBODIMENTS

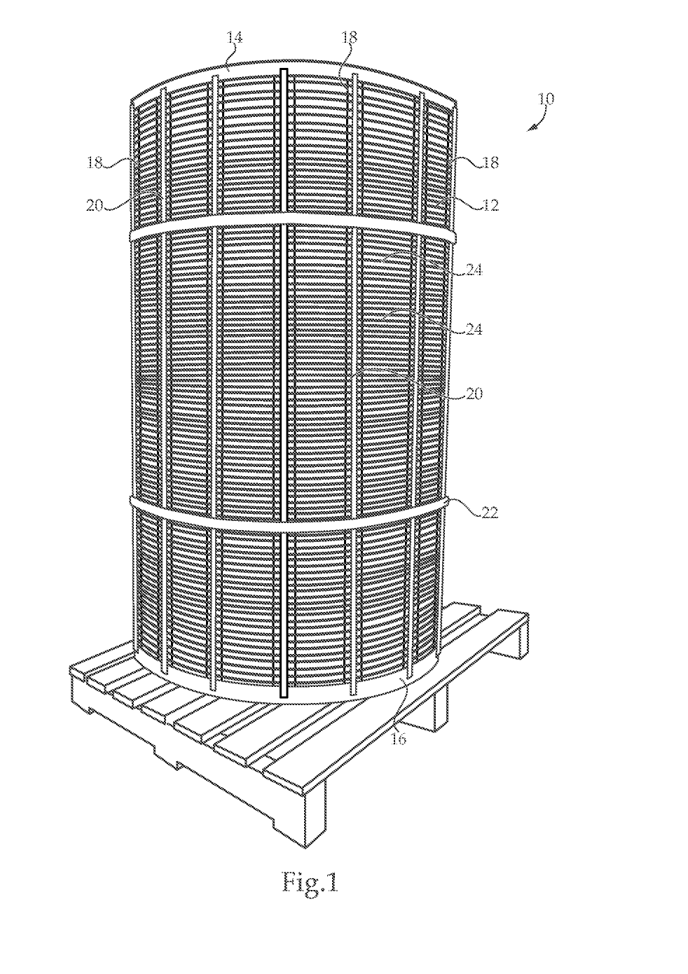

Referring to FIG. 1, there is shown a coil pack 10 for an electrical transformer according to one embodiment. Coil pack 10 includes a high voltage coil 12 comprising a plurality of axially spaced apart discs 24 formed by numerous turns of conductive material. Coil 12 is positioned between a first winding table 14 and a second winding table 16, located at opposite axial ends of coil 12. Coil 12 defines a center axis 8, and windings 24 extend circumferentially around center axis 8. When positioned for service in an electrical transformer, coil pack 10 may be positioned radially outward of a low voltage coil pack, however, the present disclosure is not thereby limited, and high and low voltage coils might be axially rather than radially spaced of have some other arrangement. Coil pack 10 further includes a plurality of turn spacers 18 positioned between adjacent discs 24. The number of spacers 18 may vary depending upon a size of coil pack 10 and the number of discs 24.

In a practical implementation strategy, spacers 18 may number well into the hundreds and in another embodiment may number well into the thousands, and may be positioned in circumferentially aligned columns spaced circumferentially about axis 8, generally as shown in FIG. 1. The present application contemplates that spacers 18 may also be positioned in offset relationships or in a non-aligned fashion. Spacers 18 may formed from material other than cellulosic material, including a thermoset material or a suitable thermoplastic material as is taught in co-pending and commonly owned PCT patent Application No. WO 2014/09399 A1. The present disclosure is nevertheless applicable without regard to material composition, except where otherwise indicated. Retention straps 22 or the like extend about coil pack 10 and are positioned radially outward of sticks 20 that position and couple spacers 18 into their respective columns. As will be further apparent from the following description, the geometry, positioning and materials of spacers 18 are exploited to enable various advantageous properties of coil pack 10 for manufacturing, system upgrades, and for service in an electrical transformer.

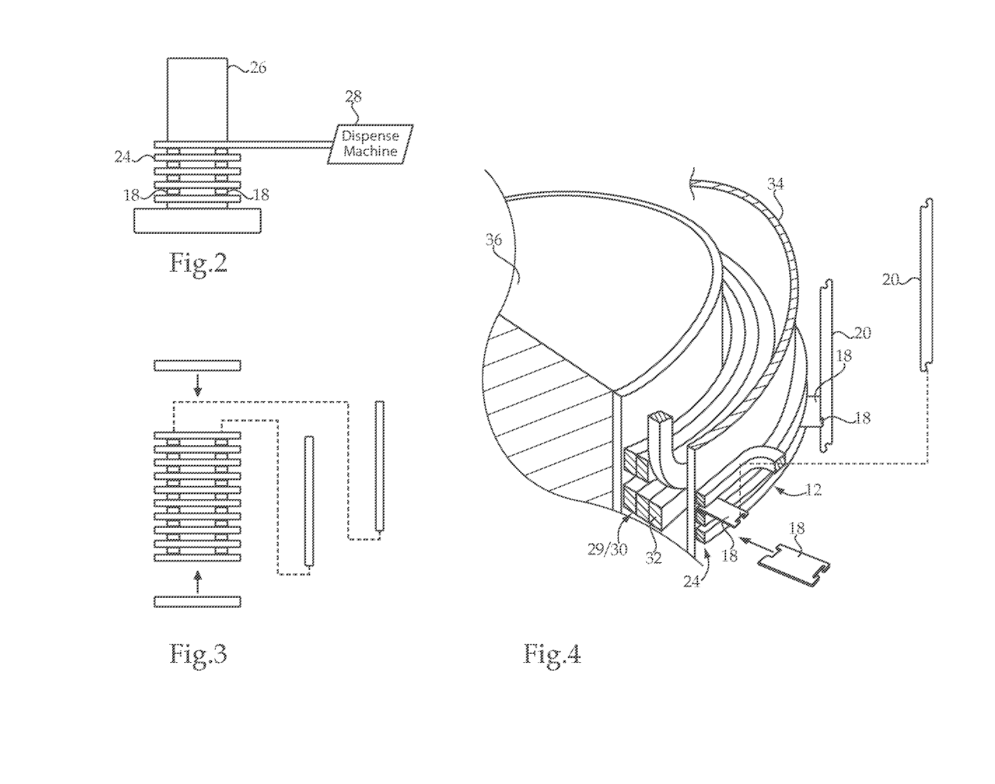

Referring also now to FIG. 2, there is shown a process stage in making coil pack 10, where discs 24 are being formed about a rotatable mandrel 26. A dispense machine 28 feeds conductive material, such as insulated copper, while mandrel 26 is rotated and spacers 18 are positioned between the plurality of discs formed by successive turns of windings. Referring also now to FIG. 3, there is shown coil pack 10 as it might appear having all of the discs 24 now formed. Spacers 18 are positioned between adjacent ones of the turns, and sticks 20 are shown as they might appear prior to being inserted through and coupled with spacers 18. Winding tables 14 and 16 are shown prior to being positioned at opposite axial ends of coil 12 discs 24.

Referring to FIG. 4, there is shown coil pack 10 positioned about a low voltage coil pack 29 having discs 30 stacked relative to one another in the axial direction. The discs 30 are formed from turns of a conductor 32. A cylinder 34 is positioned between discs 30 and discs 24. In one form the cylinder 34 is formed of a cellulose material, however the present application contemplates other materials including non-cellulose material including but not limited to the material described herein for the spacer 18. A similar cylinder might also be positioned circumferentially about discs 24. The respective coil packs 10 and 29 are shown positioned about a transformer core 36, typically comprising laminated metal sheet material. Sticks 20 and spacers 18 are shown at various states of assembly. Even though coil pack 10 and the other components might be fully assembled prior to positioning about core 36, the disassembled state depicted in FIG. 4 is useful for illustrative purposes. It can be seen that spacers 18 have been slid or otherwise positioned between turns of discs 24 in a manner that enables flow of a coolant and/or insulating fluid, typically an oil, between the turns. Although not visible in FIG. 4, spacers of identical or similar form and materials to spacers 18 may be positioned axially between turns of the conductor 32 in disc 30. It can also be noted from FIG. 4 that multiple radial layers of conductor 32 are used. Moreover, turns of the conductor 32 are shown in contact with one another. In a practical implementation strategy, such radial contact may or may not exit, and turns of the conductor 32 could instead be separated from one another via radial spacers or the like. Each disc 30 might be formed from a single turn of the conductor 32.

In a practical implementation strategy, coil pack 10 may define a spatially non-uniform heat generation profile with a plurality of hot spots located within a flow path of the coolant fluid through the coil pack. Such hot spots can be expected to develop in some instances upon or near surfaces of the turns of windings 24, potentially axially facing surfaces. Coil pack 10 may further include nonporous insulators within the hot spots, whereas porous insulators may be positioned not within the hot spots. For instance, the nonporous insulators may include spacers 18. In some instances, the presence and/or geometry of spacers 18 may in fact be responsible in part for the generation of hot spots. The porous insulators may include cylinder 34, other cylinders and/or still other components such as sticks 20 or other spacers within coil pack 10. The porous insulators may be formed of a material having a lower heat transference surface texture, and the nonporous insulators may be formed of a material having a higher heat transference surface texture so as to desensitize the transformer to temperature rise. Desensitizing the transformer to temperature rise can mean better capacity to handle high transient load demands, for instance, ultimately extending service life. In one embodiment, the nonporous insulators are formed of thermoplastic material as described herein, and the porous insulators may be formed of a cellulosic material such as paper, press board or wood. The higher heat transference surface texture may be a smoother or slicker surface texture, whereas the lower heat transference surface texture may be a rougher surface texture. As will be further apparent from the following description, the nonporous insulators may be held in axial compression via a preload, while the porous insulators are not axially loaded at all, or only minimally so. In other forms the nonporous insulators may be held in axial compression via a preload, while the porous insulators are loaded substantially the same as or a substantial fraction of the loading of the nonporous insulators.

Referring now to FIG. 5, there is shown a top view of spacer 18. It can be seen from FIG. 5 that spacer 18 has a generally rectangular footprint, including a minor axis 56 and a perpendicular major axis 58. The present application contemplates spacers of a vast variety of geometric shapes and configurations and is not limited to a generally rectangular footprint unless specifically provided to the contrary. The end shapes and locking features can vary needed to fit the needs of a particular design. Axis 58 extends between opposite ends 42 and 44, whereas minor axis 56 extends between longitudinal side edges 54. In the illustrated embodiment, spacer 18 is asymmetric about minor axis 56, and has a first slot or cutout 48 in first end 42 as well as a second slot or cutout 52 in second end 44. Slot 48 may be in the nature of a keyway having intrusions or deeper secondary cutouts 50 such that slot 48 is partially closed. This shape of slot 48 facilitates locking engagement with sticks 20, having a complementary shape. Slot 52, on the other hand, is substantially rectangular and not closed such that slot 52 enables spacer 18 to position about a radially inward spacer, but providing for some tolerance or slop in the positioning. In some embodiments, spacers 18 might be broken from a master sheet having break lines or perforations to allow a selectable or customizable spacer size. In some embodiments the terminal portions of the spacers at an end of major axis 58 may be curved to increase their length in the axial direction (the direction between separated windings) in order to provide lower susceptibility to creep. Mechanical creep is a time-dependent plastic deformation that generally occurs at elevated temperatures under a load or stress. The curve may be considered convex shaped in one form of the present application.

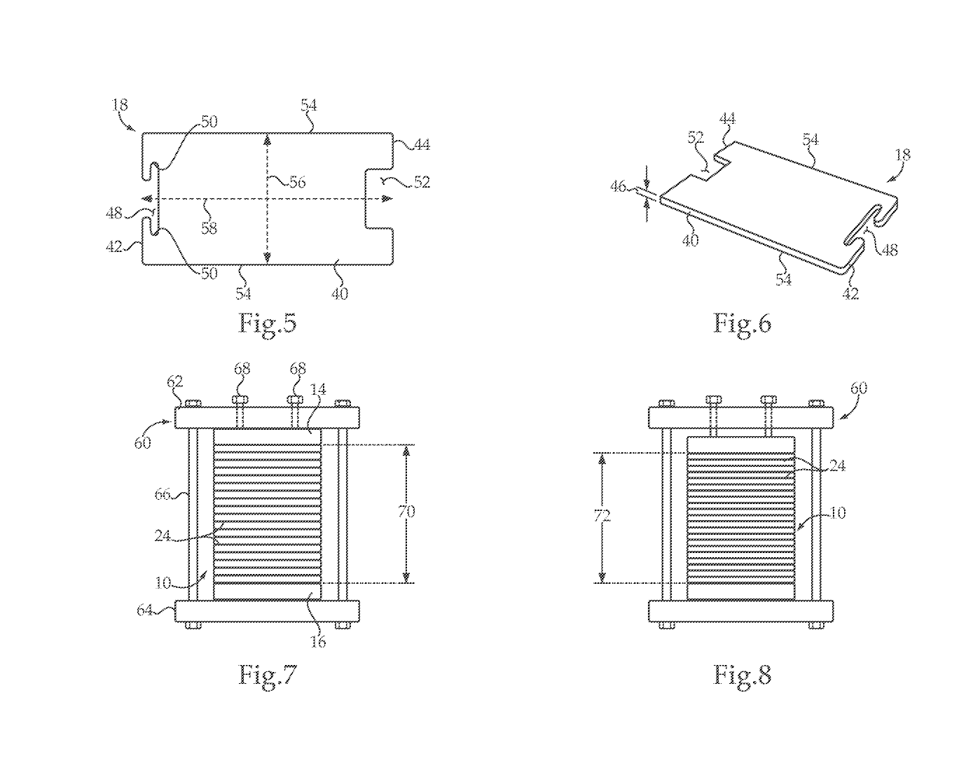

As can be seen by referring back to FIG. 4, second end 44 of each spacer 18 will typically be the end that is inserted into and amongst windings 24, such that end 42 extends outwardly from windings 24 for coupling with a stick 20. Referring also to FIG 6, illustrating a perspective view of spacer 18, there can be seen again the general rectangular form of body 40, and also a thickness of body 46. In a practical implementations strategy, a length of spacer 18 from end 42 to end 44 may be variable, and suitably tailored based upon a radial thickness of the windings, or radial thickness of multiple overlapping windings, between which spacer 18 is to be inserted. A width of spacer 18, in the direction of minor axis 56 may also be tailored, and will typically be half or less than half of the length, depending upon the environment. As noted above, earlier spacers were typically made of cellulosic materials, tending to have a surface finish relatively rough and impeding the flow of cooling fluid across the surface. Spacers 18, typically being a molded plastic material, such as a thermoplastic material, having a relatively slick surface will tend to impede cooling fluid flow substantially less than a rough surface such as that of a cellulosic spacer due to differing boundary layer effects of the two surfaces relative to a flow of cooling fluid, reducing the overall cooling load that must be managed by the transformer cooling system. Moreover, given the lesser tendency to impede fluid flow, positioning of spacers 18 is more flexible than in earlier systems. This can allow spacers 18 to be positioned at hot spots, localized higher temperature regions upon or within coil pack 10 for example, that in earlier systems would have been left totally free of obstructions. Alternatively, in earlier systems inferior spacers might have been positioned at such hot spots out of necessity, but with the expectation that the performance of the transformer would be less than optimal. Further, still, while in some instances spacers of any type might actually contribute to the generation of hot spots, spacers 18 are better able to handle the associated higher temperatures than earlier spacer configurations and material compositions.

Referring now again to FIGS. 2 and 3, but also in particular to FIG. 7, there is shown coil pack 10 as it might appear having been assembled from the state shown in FIG. 3, and now with windings 24 shown diagrammatically, and spacers 18 and sticks 20 not shown for clarity of illustration. Coil pack 10 is shown clamped in a clamping mechanism 60 having a first clamping plate 62 and a second clamping plate 64, with tie rods 66 extending between plates 62 and 64. Clamping mechanism 60 may also include jackscrews 68 or the like which can be used to exert axial compressing force on coil pack 10 to axially squeeze the same, by direct contact or by way of an intermediate plate (not shown). At the state shown in FIG. 7, coil pack 10 has a starting height 70. It is generally desirable to hold the windings of a transformer coil in a preloaded state to maintain spacing among the windings as uniformly as possible, at least where spacing is desired. By squeezing windings together in a transformer coil, deflections and vibrations of the windings during service can also be avoided, or at least reduced, to prevent thermal and mechanical fatigue that can ultimately lead to transformer failure. More specifically, the disks will be held together with spacers 18 disposed there between.

Referring also to FIG. 8, there is shown coil pack 10 as it might appear having been axially compressed via actuation of clamping mechanism 60, and reduced in axial height from a starting axial height to an in-service height 72. The starting axial height might exist where coil pack 10 is not loaded, and as suggested the in-service height will exist where coil pack 10 is properly preloaded. Earlier strategies employing cellulosic spacers suffered from unpredictability in the extent to which axial height of a coil pack could be expected to correspond to a particular preload, and also introduced unpredictability and non-uniformity into preload, especially over time. This is believed due at least in part to moisture retained within but eventually outgassed from cellulosic materials, for example press board, as well as the inherent properties of such materials such as mechanical creep-susceptibility, in other words the tendency for minute dimensional changes to occur in response to sustained external factors such as mechanical force, electrical potentials, and/or temperature of ambient oil or air. Moisture can theoretically be removed via heat treatment, but even in a best case can still have unpredictable effects on the radial or circumferential distribution of axial loads after long periods of service. This is believed due to variability in moisture content of cellulosic materials and variability in the response of even seemingly identical materials to mechanical, electrical, chemical and temperature perturbations. Moreover, it is common for the moisture removal process where cellulosic spacers are used to necessitate reapplying or adjusting preload on a coil pack following the hours of furnace or oven heating. The present disclosure contemplates greater predictability, potentially reduced or eliminated need for moisture removal via oven/furnace treatment, and extended transformer service life. Where oven/furnace treatment is used, changes to axial height can be expected to be more uniform, and minimal in comparison to earlier designs where such treatment tended to more substantially and unpredictably alter the dimensions of spacers and thus the coil pack. A coil pack may thus be preloaded once and then placed in service via installing in a transformer system, including connecting to electrical circuitry in the transformer system. Stated another way, when installed in a transformer system the preload upon a coil pack may be, within a relatively small margin of error, the same preload that was applied during manufacturing, and the axial height of the coil pack may be the in service axial height (that was determined by application of the compressive force, transitioning the coil pack from an unloaded state to a preloaded state. Further still, embodiments are contemplated where preload is applied to a coil pack in situ, in other words within a transformer system housing, and while assembled with a transformer core or a part of a transformer core.

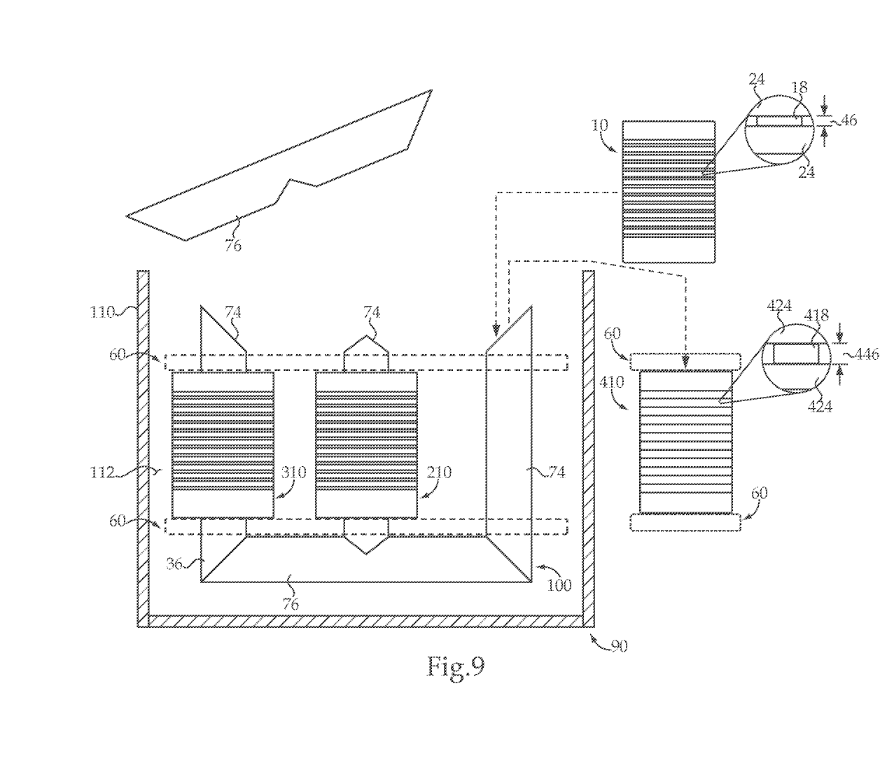

Referring now to FIG. 9, there is shown a transformer system 90 as it might appear where a transformer 100 within a housing 110 is being rebuilt or serviced. The FIG. 9 illustration can be understood to depict a part of a process performed entirely in the field, entirely at a service facility, or in part in the field or in part at a service facility. Transformer 100 includes a core 36 having three core legs 74, as would commonly be used for a three-phase application, although the present disclosure is not thereby limited. Core 36 further has first and second core bars 76, one of which is decoupled from core legs 74 to enable swapping out a used coil pack 410 of conventional design for substitute coil pack 10. The FIG. 9 illustration is diagrammatic only, and it will be appreciated that additional systems and components will typically be positioned within an interior 112 of housing 110. In the illustrated embodiment, used coil pack 410 has been removed from housing 110. Previously, coil packs 210 and 310 may have been swapped out for conventional design used coil packs similar to coil pack 410. Substitute coil pack 10 is held at its in-service axial height, from which coil pack 10 has not deviated since initial application of the preloading compressive force to the otherwise unloaded coil pack, as in FIGS. 7 and 8. Alternatively coil pack 10 might be not loaded at all, and the application of axial compressive force to preload coil pack 10 might occur after installing coil pack 10 in transformer system 90. Coil pack 10 may also be dried once assembled with core 36, and once preloaded. In certain embodiments, the greater predictability of preload and greater confidence in the consistency and preservation of preload over time can allow coil packs to be both preloaded and dried in situ rather than by way of the relatively labor intensive techniques of earlier systems. Thus, in reference to the FIG. 9 illustration, vacuum and heating techniques such as hot oil circulation or hot oil spraying for transformer drying can be applied once each of the coil packs is assembled with the transformer core. It shall be appreciated that the use of non-cellulosic spacers such as those formed of thermoplastic material may eliminate the need for heat treatment processing to remove moisture from the transformer coil prior to insertion into the transformer. If additional cellulosic materials are present in the transformer, a subsequent heat treatment processing may be utilized to remove moisture, but with substantial savings of time and energy relative to techniques utilizing a coil with conventional cellulosic spacers. In one embodiment wherein mineral oil is the original insulating fluid, when the substitute coil pack having non-cellulose spacers is installed, the insulating fluid is replaced with natural or synthetic ester.

It also can be seen from FIG. 9 that windings 24 in coil pack 10 are relatively more tightly packed together than windings 424 in coil pack 410. This is perhaps best evident in the detailed enlargements in FIG. 9, where it can be seen that spacer 18 has an axial thickness less than spacer 418 of coil pack 410. Axial thickness of spacer 18 is shown via reference numeral 46, whereas axial thickness of spacer 418 is shown via reference numeral 446. Thus, in the case of either of coil pack 10 or 410 the spacing of the turns can be understood to be based on a thickness of the turn spacers. In the case of coil pack 10 the spacer thickness is lesser, and the turn number is greater. In the case of coil pack 410 the spacer thickness is greater and the turn number is lesser. The spacing in the respective coil packs may be a mean axial spacing between adjacent turns of the windings. However, the present application also contemplates that the thickness of the spacer is not varied based upon the material properties of the spacer. Therefore, the present application contemplates in at least one form that the thickness of the spacer whether formed of cellulose or non-cellulose material may be the same.

As discussed above, the response of spacers 18 can be expected to be more predictable than that of cellulosic spacers insofar as preload is concerned. Another way to understand this principle is that application of “X” Newtons of preload force to coil pack 10 can be expected to deform spacers 18 in a more uniform and predictable manner, and typically to a lesser extent, than application of the same preload force to coil pack 410. This reduces the tolerance that is needed respecting spacing of turns of windings 24 from one another as compared to turns of windings 424. For this reason, windings 24, and in particular the conductive material thereof, can be more spatially dense in coil pack 10 that the conductive material in coil pack 410. The differing responses of different spacer types to compressive loading can be observed over relatively short time periods, and also over longer time periods on the order of years or decades. As noted above, cellulosic materials can be understood as relatively susceptible to so-called creep, whereas other materials such as thermoplastics can be understood to be relatively creep-resistant. Empirical testing has demonstrated that conventional press board can experience mechanical creep in the nature of deformation that is from about 50% greater at 500 hours to about 100% greater at 1200 hours than the deformation observed for certain thermoplastic resins. The difference was observed using samples of conventional commercially available press board and thermoplastic resin available from SABIC Corporation under the trade name ULTEM. The samples were subjected to similar experimental conditions of oil impregnation/soaking, compressive loading and sustained temperatures of 110 degrees C.

From the foregoing discussion, it will be understood that given a predefined spatial envelope the present disclosure allows greater transformer power density than earlier strategies. In this vein, embodiments are contemplated where a transformer is disassembled for service, and one or more used coil packs, whether damaged, degraded, or still in acceptable working order, are swapped out for substitute coil packs built in accordance with the present disclosure. This enables a power upgrade to a transformer system without redesign or replacement of components other than the coil packs, since the substitute coil packs can be placed within the exact same spatial footprint in the transformer that was occupied by the previous used coil pack it is replacing. Coupled with the reduced heat loads that need to be managed in a transformer cooling system, given the enhanced cooling fluid flow efficacy and heat transference as described herein, the present disclosure provides for premium transformer design, operation and longevity.

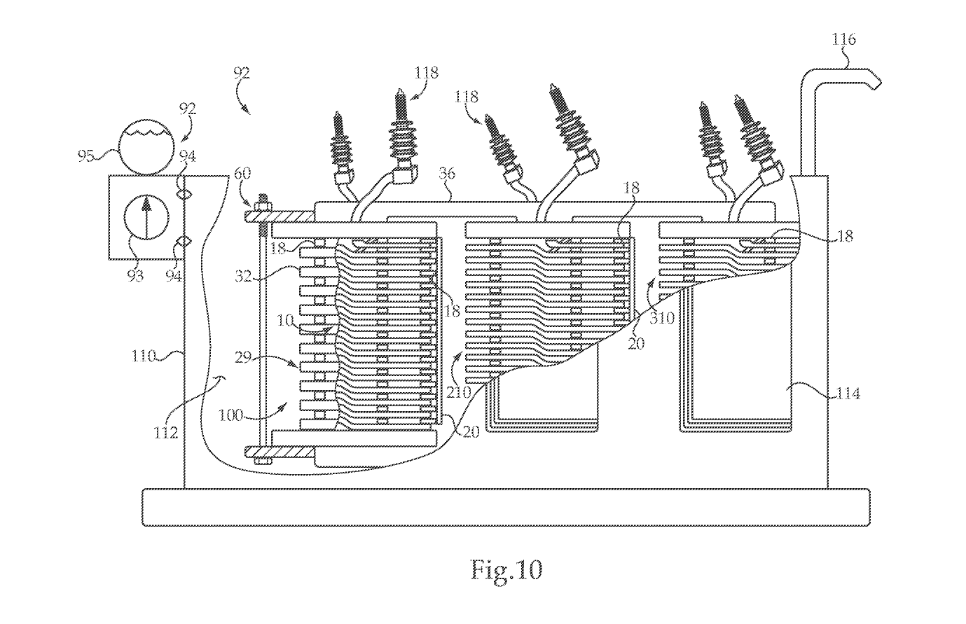

Referring now to FIG. 10, there is shown coil pack 10 along with coil packs 210 and 310 as they might appear positioned within housing 110 of transformer system 90, and along with additional transformer system components. It can be seen that a vent pipe 116 or the like is attached to housing 110 as is a cooling system 92. Cooling system 92 circulates cooling and/or insulating fluid, such as mineral oil, natural ester dielectric fluid or synthetic ester dielectric fluid through housing 110 and includes a pump 93 connected with interior 112 of housing 110 via first and second inlet/outlet ports 94 or the like. Cooling system 92 further includes a tank 95 that may store some volume of the coolant fluid, and interior 112 may be at least partially flooded with coolant fluid as well. Radiators 114 are attached to housing 110, and will typically include coolant circulation loops therethrough. Also shown in FIG. 10 are transformer bushings 118, two of which are associated with each of coil packs 10, 210 and 310. In each of the pairs of bushings 118, one bushing may connect to a low voltage coil and the other may connect to a high voltage coil, of each coil pack. Coil pack 10 is shown partially open, such that windings 32, separated by spacers 18, are visible. Sticks 20 are also shown inside view but omitted from the illustration to show the general arrangement of spacers 18 and windings in each of the coil packs. It will be appreciated not only that coil pack 10 has been installed while at its in-service axial height and the initial preload, but also the coil pack 10 can be electrically connected to circuitry within system 90 without relieving preload and/or reapplying preload following the first instance, and without any substantial change to its axial height since the processing stage of FIG. 8.

Referring back to the previously discussed material the present application contemplates an embodiment free of cellulose material on the conductive windings and the axial spacers between the disks are formed of non-cellulose material. In one form the coating on the conductive material is an enamel coating or a polymeric material such as Durabil.

Referring back to the previously disclosed material the present application contemplates a manufacturing process wherein the stack of conductive disk windings are separated by cellulose free spacers and are put in a preload but not subjected to a thermal cycle to reduce the moisture content of the assembly until it is assembled into the transformer. Further, in one aspect the conductive windings are coated with a cellulose free material such as an enamel coating or a polymeric material such as Durabil.

The present description is for illustrative purposes only, and should not be construed to narrow the breadth of the present disclosure in any way. Thus, those skilled in the art will appreciate that various modifications might be made to the presently disclosed embodiments without departing from the full and fair scope and spirit of the present disclosure. Other aspects, features and advantages will be apparent upon an examination of the attached drawings and appended claims.

1. A method of servicing a transformer system comprising:
disassembling a used coil pack from a core of a transformer, the used coil pack including a first plurality of winding disks axially spaced apart from one another by a plurality of spacer members comprising a cellulosic material;
assembling a substitute coil pack with the core, the substitute coil pack including a second plurality of winding disks axially spaced apart from one another by a second plurality of spacer members comprising a non-cellulosic material; and
placing the substitute coil pack within the same spatial footprint in the transformer that was occupied by the used coil pack,

2. The method of claim 1 further comprising operating the transformer system with the substitute coil pack at substantially the same power as the transformer system with the used coil pack wherein the substitute coil pack exhibits a lower operating temperature than the used coil pack at substantially the same operating power.

3. The method of claim 1 wherein the non-cellulosic material includes a thermoplastic material.

4. The method of claim 1 further comprising operating the transformer system with the substitute coil pack at a higher power than the transformer system with the used coil pack wherein the substitute coil pack exhibits an operating temperature that is the same as or lower than the operating temperature of the used coil pack.

5. The method of claim 1 wherein the windings are a conductive material with a non cellulose coating selected from one of an enamel coating and a polymeric material; and further wherein the resulting transformer system is operable at higher temperatures with less aging of the windings relative to the operation at the higher temperatures with the configuration of the used coil pack.

6. A method of preparing a transformer system for service comprising;
receiving a winding subassembly having a coil of windings defining a center axis, spacers positioned between turns of the windings, and axially extending sticks coupling together circumferentially aligned columns of the spacers;
positioning a first and a second winding table at opposite axial ends of the coil, such that the winding subassembly and winding tables form a coil pack having a starting axial height;
applying axial compressive force to the winding tables so as to preload the coil pack and shorten the coil pack from the starting axial height to an in-service axial height; and
installing the coil pack for service in the transformer system at the in-service axial height, as determined by the applied axial compressive force;
wherein the installing is performed without temperature processing the coil pack to remove moisture.

7. The method of claim 6 wherein installing the coil pack further includes electrically connecting the coil pack to circuitry in the transformer system at the in-service axial height as determined by the applied axial compressive force, and wherein the spacers are formed of a mechanical-creep-resistant thermoplastic material.

8. The method of claim 5 wherein the coil pack is in a not loaded state at the starting axial height, and further comprising transitioning the coil pack from the not loaded state to a preloaded state via the application of the axial compressive force, and assembling the coil pack at the in-service axial height with a transformer core.

9. The method of claim 8 wherein the receiving of the winding subassembly further includes receiving the winding subassembly where the spacers are formed of a non-cellulosic mechanical-creep-resistant material.

10. The method of claim 9 wherein the windings comprise a conductive material coated with a non-cellulose material.

11. The method of claim 6 further comprising, after the installing further comprising temperature processing the coil pack effective to remove moisture from components of the transformer other than the coil pack.

12. An electrical transformer system comprising:
a housing;
a fluid cooling system including ports to an interior of the housing;
a transformer within the interior of the housing and including a core, and a coil pack coupled with the core;
the coil pack including a coil of windings defining a center axis and having a first axial end and a second axial end, and a plurality of turns about the center axis between the first axial end and the second axial end;
the coil pack further including a plurality of spacers formed of thermoplastic heat
resistant material and positioned between adjacent ones of the turns, a plurality of sticks coupling together circumferentially aligned columns of the plurality of spacers, and a first and a second winding table positioned at the first and second axial ends, respectively;
the coil pack further defining a spatially non-uniform heat generation profile with a plurality of hot spots located within a flow path of the coolant fluid through the coil pack, and including nonporous insulators within the hot spots and porous insulators not within the hot spots; and
the porous insulators being formed of a material having a lower heat transference surface texture, and the nonporous insulators being formed of a material having a higher heat transference surface texture so as to desensitize the transformer to temperature rise.

13. The transformer system of claim 12 wherein the spacers include the nonporous insulators.

14. The transformer system of claim 12 wherein the nonporous insulators include a thermoplastic material and the porous insulators include a cellulosic material.

15. The transformer system of claim 12 further comprising a clamping mechanism, and wherein the nonporous insulators are held in axial compression via a preload applied by the clamping mechanism, and the porous insulators are not axially loaded.

16. The transformer system of claim 12, further comprising a pump for circulating coolant fluid through the housing.

17. A method of field servicing a transformer system comprising:
disassembling a used coil pack from a transformer core within a transformer housing, where the used coil pack includes windings and a plurality of spacers formed of a porous cellulosic insulating material and positioned between adjacent turns of the windings in the used coil pack;
assembling a substitute coil pack with the transformer core, where the substitute coil pack includes windings defining a center axis and a plurality of spacers formed of a nonporous noncellulosic insulating material and positioned between adjacent turns of the windings in the substitute coil pack;
applying a preload to the substitute coil pack so as to reduce an axial height of the coil pack from a starting axial height to an in-service axial height; and
connecting the substitute coil pack as assembled with the transformer core and preloaded with electrical circuitry of the transformer system for service therein without processing the substitute coil pack to dry or remove moisture therefrom.

18. The method of claim 17 wherein the applying of the preload includes applying the preload so as to reduce the axial height of the coil pack from a starting axial height in a not loaded state to an in-service axial height in a preloaded state.

19. The method of claim 17 wherein the applying of the preload includes applying the preload while the substitute coil pack is assembled with the transformer core or assembled with a part of the transformer core.

20. The method of claim 19 wherein the substitute coil pack has a higher density of conductive material than the used coil pack.

21. The method of claim 20 further comprising after the act of heat processing the transformer to remove moisture from a transformer component other than the substitute coil pack.

22. A method of preparing a transformer system for service comprising:
receiving a winding subassembly having windings defining a center axis, spacers
positioned between turns of the windings, and axially extending sticks coupling together circumferentially aligned columns of the spacers;
positioning a first and a second winding table at opposite axial ends of the windings, such that the winding subassembly and winding tables form a coil pack having a starting axial height;
installing the coil pack within a housing of the transformer system and assembling the coil pack with a transformer core;
applying axial compressive force to the winding tables so as to preload the coil pack and shorten the coil pack from the starting axial height to an in-service axial height while installed within the transformer housing and assembled with the transformer core; and
connecting the coil pack with electrical circuitry of the transformer system for service therein.

23. The method of claim 22 wherein the applying of axial compressive force includes applying the axial compressive force prior to installing the coil pack in the transformer system.

24. An electrical transformer system comprising:
a housing;
a fluid cooling system including ports to an interior of the housing;
a transformer within the interior of the housing and including a core, and a coil pack coupled with the core;
the coil pack including windings defining a center axis and having a first axial end and a second axial end, and a plurality of turns about the center axis between the first axial end and the second axial end;
the coil pack further defining a spatially non-uniform heat generation profile with a plurality of hot spots located within a flow path of the coolant fluid through the coil pack, and including nonporous insulators within or adjacent to the hot spots and porous insulators not within and not adjacent to the hot spots; and
the porous insulators being formed of a material having a lower heat transference surface texture, and the nonporous insulators being formed of a material having a higher heat transference surface texture.

25. The transformer system of claim 24 wherein the nonporous insulators include spacers positioned between adjacent turns of the windings.

26. The transformer system of claim 24, further comprising a pump for circulating coolant fluid through the housing.

27. A method of servicing a transformer system comprising:
disassembling a used coil pack from a core in a transformer, where the used coil pack includes windings having a lesser number of turns, and a greater spacing among the turns based on a greater thickness of turn spacers formed of a creep-susceptible cellulosic material;
assembling a substitute coil pack with the core, where the substitute coil pack includes windings in a greater number of turns, and a lesser spacing of the turns based on a lesser thickness of turn spacers formed of a creep-resistant non-cellulosic material; and
placing the substitute coil pack within the same spatial footprint in the transformer that was occupied by the used coil pack.

28. The method of claim 27 wherein each of the used coil pack and the substitute coil pack defines a center axis, and wherein each of the greater spacing and the lesser spacing includes a mean axial spacing within the corresponding coil pack such that the substitute coil pack has a greater density of conductive material than the used coil pack.

29. The method of claim 28 wherein the creep-resistant material includes a thermoplastic material.

30. A liquid immersed power transformer comprising:
a housing;
a plurality of disk windings of a conductive material coated with one of an enamel and a polymeric insulator material and free of cellulose based material;
a plurality of mechanical spacers formed of a cellulose free material, wherein each of the disk windings are separated from one another by the mechanical spacers; and
a fluid flow path defined between respective pairs of the plurality of disk windings and the surface of the mechanical spacers disposed with the fluid flow paths are smooth and the spacers are substantially impregnable to cooling fluid circulated through the fluid flow path.

31. The liquid immersed power transformer of claim 30, wherein the plurality of disk windings and plurality of mechanical spacers form a dimensionally stable coil pack that is substantially free from the adverse effects of transformer aging.

32. The liquid immersed power transformer of claim 30, wherein the plurality of disk winding have been subjected to no additional beat processing operation during manufacturing than the rest of the power transformer.

33. (canceled)
